(19) United States
(12) Patent Application Publication
(10) Pub. No.: US 2014/0057175 A1
(43) Pub. Date: Feb. 27, 2014

(54) CATHODE ACTIVE MATERIALS FOR LITHIUM SECONDARY BATTERY AND PREPARATION METHOD THEREOF

(71) Applicant: KOREA INSTITUTE OF SCIENCE AND TECHNOLOGY, (US)

(72) Inventors: Kyung Yoon CHUNG, Seoul (KR); Byung Won CHO, Seoul (KR); Won Young CHANG, Seoul (KR); Jae Hyung CHO, Gyeonggi-do (KR); Jae-kyo NOH, Chungbuk (KR); Soo KIM, Daejeon (KR); Sujin KIM, Gyeonggi-do (KR)

(73) Assignee: KOREA INSTITUTE OF SCIENCE AND TECHNOLOGY, Seoul (KR)

(21) Appl. No.: 13/742,108

(22) Filed: Jan. 15, 2013

(30) Foreign Application Priority Data
Aug. 22, 2012 (KR) 10-2012-0091913

(51) Int. Cl. H01M 4/505; H01M 4/36

(52) U.S. Cl. CPC H01M 4/505; H01M 4/366
USPC 429/220; 429/224; 429/223; 429/221; 427/126.3; 427/126.6

(57) ABSTRACT

Provided is a cathode active material for a lithium secondary battery and a method for preparing the same. The cathode active material for a lithium secondary battery allows a lithium secondary battery to realize high capacity and to maintain maximum capacity even at high voltage, prevents a drop in capacity during repeated charge/discharge cycles, and improves the lifespan of a lithium secondary battery.

### CROSS-REFERENCE TO RELATED APPLICATIONS

This application claims priority under 35 U.S.C. §119 to Korean Patent Application No. 10-2012-0091913 filed on Aug. 22, 2012, in the Korean Intellectual Property Office, the disclosure of which is incorporated herein by reference in its entirety.

### TECHNICAL FIELD

The following disclosure relates to a cathode active material for a lithium secondary battery and a method for preparing the same. More particularly, the following disclosure relates to a cathode active material for a lithium secondary battery, which improves the charge/discharge efficiency and capacity of a lithium secondary battery, and a method for preparing the same.

### BACKGROUND

Since lithium secondary batteries were developed in 1991 as compact, light and high-capacity batteries, they have been used widely as power sources for portable instruments. More recently, as electronic, communication and computer industries have been developed rapidly, camcorders, mobile phones, notebook personal computers, or the like have appeared and undergone significant development continuously. Under these circumstances, lithium secondary batteries have been increasingly on demand as driving power sources for such portable electronic, information and communication instruments.

Such lithium secondary batteries use LiCoO₂, LiNiO₂, or the like as a cathode active material, and a carbonaceous material, such as graphite, as an anode active material. Particularly, the cathode active material forming a cathode has a layered structure, and charge/discharge cycles are repeated while lithium ions are intercalated/deintercalated to/from the interlayer space of the layered structure.

However, since lithium ions continuously move from/to the interlayer space during repeated charge/discharge cycles as mentioned above, the cathode of a lithium secondary battery is deteriorated and causes a drop in capacity. In addition, the lifespan of a lithium secondary battery is reduced accordingly.

Further, due to the direct exposure of such a layered structure, the material used as an electrolyte may be eluted out.

To solve the above problems, many studies have been conducted about modification of a cathode active material. However, such modification may result in an increase in electrical resistance. Therefore, it is difficult to maintain the capacity of a lithium secondary battery and to prevent degradation of lifespan thereof during repetition of charge/discharge cycles while not disturbing lithium ion movement even after such modification.

### SUMMARY

An embodiment of the present disclosure is directed to providing a cathode active material for a lithium secondary battery, obtained by surface modification of a cathode active material for a lithium secondary battery having a layered structure so that a lithium secondary battery realizes high capacity and maintains maximum capacity even at high voltage, undergoes no drop in capacity during repeated charge/discharge cycles, and causes no degradation of lifespan. Another embodiment of the present disclosure is directed to providing a method for preparing the cathode active material for a lithium secondary battery.

In one general aspect, there is provided a cathode active material for a lithium secondary battery, including LiXO₂ coated with Li₂MnO₃, wherein X is at least one metal selected from the group consisting of nickel (Ni), cobalt (Co), manganese (Mn), aluminum (Al), copper (Cu), iron (Fe), magnesium (Mg), bismuth (Bi) and gallium (Ga).

According to an embodiment, LiXO₂ may be at least one selected from the group consisting of LiCoO₂, LiNiO₂, LiNixCo₁₋ₓO₂ (wherein 0<x<1) and LiNi_{1-x-y}CoₓX′_{y}O₂ (wherein 0<x<1, 0<y<1 and 0<x+y<1, and X′ is at least one selected from the group consisting of aluminum (Al), strontium (Sr), magnesium (Mg), iron (Fe) and manganese (Mn)).

According to another embodiment, the Li₂MnO₃ coating may have a thickness of 10 nm-500 nm.

According to still another embodiment, the cathode active material for a lithium secondary battery may allow the lithium secondary battery including the same to maintain its capacity to such a degree that the capacity after repeating charge/discharge cycles six times or more is within ±5 mAh/g as compared to the capacity of the 6^{th} cycle.

In another general aspect, there is provided a method for preparing a cathode active material for a lithium secondary battery, including: mixing a lithium compound with a manganese compound to obtain Li₂MnO₃; introducing Li₂MnO₃ to a solution in which LiXO₂ is dispersed and mixing them so that LiXO₂ is coated with Li₂MnO₃; and drying the resultant mixed solution, wherein X is at least one metal selected from the group consisting of nickel (Ni), cobalt (Co), manganese (Mn), aluminum (Al), copper (Cu), iron (Fe), magnesium (Mg), bismuth (Bi) and gallium (Ga).

According to an embodiment, the Li₂MnO₃ coating may have a thickness of 10 nm-500 nm.

According to another embodiment, the lithium compound may be LiCO₃ or LiOH, and the manganese compound may be at least one selected from the group consisting of Mn₂O₃, MnO₂, MnO, Mn₃O₄ and Mn(OH)₂.

According to still another embodiment, the method may further include, after mixing a lithium compound with a manganese compound, heat treating the resultant mixture to obtain Li₂MnO₃.

According to still another embodiment, the method may further include, after drying the mixed solution, carrying out heat treatment, wherein the heat treatment may be carried out by introducing air or oxygen.

According to still another embodiment, the heat treatment may be carried out at a temperature of 400-1,100° C.

According to still another embodiment, when mixing the lithium compound with the manganese compound, at least one element selected from the group consisting of magnesium (Mg), aluminum (Al), calcium (Ca), titanium (Ti), vanadium (V), chrome (Cr), iron (Fe), copper (Cu), zinc (Zn), gallium (Ga), zirconium (Zr), molybdenum (Mo), tin (Sn), antimony (Sb), tungsten (W) and bismuth (Bi) may be added thereto.

According to still another embodiment, LiXO₂ may be at least one selected from the group consisting of LiCoO₂, LiNiO₂, LiNixCo₁₋ₓO₂ (wherein 0<x<1) and LiNi_{1-x-y}CoₓX′_{y}O₂ (wherein 0<x<1, 0<y<1 and 0<x+y<1, and X′ is at least one selected from the group consisting of aluminum (Al), strontium (Sr), magnesium (Mg), iron (Fe) and manganese (Mn)).

According to still another embodiment, the lithium compound and the manganese compound may be mixed with each other at a molar ratio of 1-3:0.5-1.5.

According to still another embodiment, the solution in which LiXO₂ is dispersed may include LiXO₂ in an amount of 5-40 wt % based on the weight of the solvent.

According to yet another embodiment, Li₂MnO₃ may be introduced to LiXO₂ at a molar ratio of 1-9:1-9 (LiXO₂:Li₂MnO₃).

In still another general aspect, there is provided a lithium secondary battery including the cathode active material for a lithium secondary battery disclosed herein.

The cathode active material for a lithium secondary battery disclosed herein allows a lithium secondary battery to realize high capacity and to maintain maximum capacity even at high voltage, prevents a drop in capacity during repeated charge/discharge cycles, and improves the lifespan of a lithium secondary battery.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a transmission electron microscopy (TEM) image showing the surface states of the cathode active materials for a lithium secondary battery according to Examples 1-3;

FIG. 2 is a graph illustrating a change in capacity as a function of voltage in Examples 1-5 and Comparative Example 1; and

FIG. 3 is a graph illustrating a change in capacity as a function of number of repeating charge/discharge cycles in Examples 1-5 and Comparative Example 1.

### DETAILED DESCRIPTION OF EMBODIMENTS

The advantages, features and aspects of the present disclosure will become apparent from the following description of the embodiments with reference to the accompanying drawings, which is set forth hereinafter.

The inventors have conducted many studies to develop a cathode active material for a lithium secondary battery, which allows a lithium secondary battery to realize and maintain high capacity even at high voltage and to provide high efficiency, prevents a drop in capacity during repeated charge/discharge cycles, and improves the lifespan of a lithium secondary battery. As a result, we have found such a cathode active material for a lithium secondary battery and a method for preparing the same, and the present disclosure is based on this finding.

In general, a cathode active material for a lithium secondary battery has a layered structure and lithium ions move actively through the interlayer space of such a layered structure. However, such continuous movement of lithium ions through repeated charge/discharge cycles gradually causes a drop in capacity of a lithium secondary battery, while adversely affecting the lifespan thereof.

Therefore, the present disclosure is directed to providing a cathode active material for a lithium secondary battery, which allows a lithium secondary battery to maintain its capacity during repeated charge/discharge cycles, and to realize and maintain high capacity even at high voltage, while improving the lifespan of a lithium secondary battery.

In one aspect, the cathode active material for a lithium secondary battery disclosed herein includes LiXO₂ coated with Li₂MnO₃, wherein X is at least one metal selected from the group consisting of nickel (Ni), cobalt (Co), manganese (Mn), aluminum (Al), copper (Cu), iron (Fe), magnesium (Mg), bismuth (Bi) and gallium (Ga).

In addition, LiXO₂ (wherein X is a metal) is not particularly limited, as long as it is capable of forming a cathode for a lithium secondary battery and allows smooth reciprocation of lithium ions through the interlayer space of the layered structure. Particularly, LiXO₂ may be at least one selected from the group consisting of LiCoO₂, LiNiO₂, LiNixCo₁₋ₓO₂ (wherein 0<x<1) and LiNi_{1-x-y}CoₓX′_{y}O₂ (wherein 0<x<1, 0<y<1 and 0<x+y<1, and X′ is at least one selected from the group consisting of aluminum (Al), strontium (Sr), magnesium (Mg), iron (Fe) and manganese (Mn)).

The Li₂MnO₃ coating may have a thickness of 10 nm-500 nm. When the coating thickness is less than 10 nm, it is difficult to obtain a desired effect of Li₂MnO₃ coating. On the other hand, when the coating thickness exceeds 500 nm, it is difficult to obtain advantages of LiXO₂ as a cathode active material for a lithium secondary battery.

In addition, Li₂MnO₃ may have a size of 5 nm-100 nm to obtain such a thickness of Li₂MnO₃ coating. When Li₂MnO₃ has a size less than 5 nm, the coating is too thin to obtain a desired effect of coating. On the other hand, when Li₂MnO₃ has a size larger than 100 nm, the coating is too thick to obtain advantages of LiXO₂ as a cathode active material for a lithium secondary battery.

The cathode active material for a lithium secondary battery, including LiXO₂ coated with Li₂MnO₃, allows a lithium secondary battery to realize high capacity and to maintain maximum capacity even at high voltage, prevents a drop in capacity during repeated charge/discharge cycles of a lithium secondary battery to maintain constant capacity, and improves the lifespan of a lithium secondary battery.

The cathode active material for a lithium secondary battery, including LiXO₂ coated with Li₂MnO₃, allows a lithium secondary battery including the same to maintain its capacity to such a degree that the capacity after repeating charge/discharge cycles six times or more is within ±5 mAh/g as compared to the capacity of the 6^{th} cycle.

In addition, since a lithium secondary battery including the cathode active material disclosed herein maintains it capacity continuously, it is possible to improve the lifespan of a lithium secondary battery as compared to a cathode active material for a lithium secondary battery merely including LiXO₂ not coated with Li₂MnO₃. The cathode active material for a lithium secondary battery merely including LiXO₂ not coated with Li₂MnO₃ gradually causes a drop in capacity during repeated charge/discharge cycles, resulting in degradation of the lifespan of a lithium secondary battery.

In another aspect, the method for preparing a cathode active material for a lithium secondary battery, includes: mixing a lithium compound with a manganese compound to obtain Li₂MnO₃; introducing Li₂MnO₃ to a solution in which LiXO₂ is dispersed and mixing them so that LiXO₂ is coated with Li₂MnO₃; and drying the resultant mixed solution, wherein X is at least one metal selected from the group consisting of nickel (Ni), cobalt (Co), manganese (Mn), aluminum (Al), copper (Cu), iron (Fe), magnesium (Mg), bismuth (Bi) and gallium (Ga).

Particularly, there is no particular limitation in the lithium compound, as long as it is bound chemically with a manganese compound and causes no change in functions as a cathode active material for a lithium secondary battery even when it is applied in the form of a cathode active material for a lithium secondary battery. More particularly, the lithium compound may be LiCO₃ or LiOH.

In addition, there is no particular limitation in the manganese compound, as long as it is bound chemically with a lithium compound and causes no change in functions as a cathode active material for a lithium secondary battery even when it is applied in the form of a cathode active material for a lithium secondary battery. More particularly, the manganese compound may be at least one selected from the group consisting of Mn₂O₃, MnO₂, Mn₃O₄ and Mn(OH)₂.

There is no particular limitation in amount used in mixing a lithium compound with a manganese compound, as long as each compound is present at a concentration sufficient to form chemical bonding. Particularly, the lithium compound may be mixed with the manganese compound at a molar ratio of 1-3:0.5-1.5. When the lithium compound is used in an amount of a molar ratio less than 1, the manganese compound remains undesirably after mixing. On the other hand, when the lithium compound is used in an amount of a molar ratio larger than 3, an excessive amount of lithium compound remains unreacted, which is not favorable to cost efficiency.

When the manganese compound is used in an amount of a molar ratio less than 0.5, the lithium compound remains undesirably after mixing. On the other hand, when the manganese compound is used in an amount of a molar ratio larger than 1.5, an excessive amount of manganese compound remains unreacted, which is not favorable to cost efficiency.

The above-defined molar ratio of mixing the lithium compound with the manganese compound gives no delay in reaction time.

The method for mixing the lithium compound with the manganese compound is not particularly limited, and any known apparatus for agitation and stirring may be used.

When mixing the lithium compound with the manganese compound, at least one element selected from the group consisting of magnesium (Mg), aluminum (Al), calcium (Ca), titanium (Ti), vanadium (V), chrome (Cr), iron (Fe), copper (Cu), zinc (Zn), gallium (Ga), zirconium (Zr), molybdenum (Mo), tin (Sn), antimony (Sb), tungsten (W) and bismuth (Bi) may be added thereto as a dopant.

The dopant may be added in a molar ratio of 0.01-2 moles based on the total moles of the mixture of lithium compound with manganese compound. When the dopant is added in an amount less than 0.01 moles, it is not possible to obtain a sufficient effect of the dopant. On the other hand, when the dopant is added in an amount greater than 2 moles, an undesirably excessive amount of dopant is added, which is not favorable to cost efficiency.

Such addition of a dopant upon mixing the lithium compound with the manganese compound enhances the effect of coating LiXO₂ with Li₂MnO₃.

The Li₂MnO₃ coating may have a thickness of 10 nm-500 nm. When the coating thickness is less than 10 nm, it is difficult to obtain a sufficient effect of Li₂MnO₃ coating. On the other hand, when the coating thickness exceeds 500 nm, it is difficult to obtain advantages of LiXO₂ as a cathode active material for a lithium secondary battery.

There is no particular limitation in size of Li₂MnO₃ obtained from the mixing, as long as Li₂MnO₃ allows modification of LiXO₂ when coated thereon and accomplishes the above-defined Li₂MnO₃ coating thickness. However, Li₂MnO₃ may have a size of 5 nm-100 nm.

When Li₂MnO₃ has a size less than 5 nm, the coating is too thin to obtain a desired effect. On the other hand, when Li₂MnO₃ has a size larger than 100 nm, interstitial volumes are generated in the particles due to such a large particle size and the coating is too thick to obtain functions of LiXO₂ as a cathode active material for a lithium secondary battery.

According to an embodiment, after mixing a lithium compound with a manganese compound, heat treating the resultant mixture to obtain Li₂MnO₃. Such heat treatment allows Li₂MnO₃ to realize its characteristics as oxide better and makes the particles denser. The heat treatment may be carried out at a temperature of 400-1,100° C. When the heat treatment is carried out at a temperature lower than 400° C., it is not possible to obtain a sufficient effect of heat treatment. On the other hand, when the heat treatment is carried out at a temperature higher than 1,100° C., the resultant Li₂MnO₃ may be degraded due to such an excessively high temperature.

Upon mixing, LiXO₂ may be dispersed into an aqueous solution to which a surfactant is added. More particularly, alcohol (a preferred organic solvent) may be added as a co-solvent to the aqueous solution to which a surfactant is added.

In addition, LiXO₂ (wherein X is a metal) is not particularly limited, as long as it is capable of forming a cathode for a lithium secondary battery and allows smooth reciprocation of lithium ions through the interlayer space of the layered structure. Particularly, LiXO₂ may be at least one selected from the group consisting of LiCoO₂, LiNiO₂, LiNixCo₁₋ₓO₂ (wherein 0<x<1) and LiNi_{1-x-y}CoₓX′_{y}O₂ (wherein 0<x<1, 0<y<1 and 0<x+y<1, and X′ is at least one selected from the group consisting of aluminum (Al), strontium (Sr), magnesium (Mg), iron (Fe) and manganese (Mn)).

Although there is no particular limitation in amount of LiXO₂ mixed with the aqueous solution as long as LiXO₂ is dispersed in the solution, LiXO₂ may be mixed in an amount of 5-40 wt % based on the weight of the solvent. When the amount of LiXO₂ is less than 5 wt %, LiXO₂ is too insufficient to accomplish adequate dispersion, and the cathode active material for a lithium secondary battery is produced in an excessively insufficient amount. When the amount of LiXO₂ is greater than 40 wt %, an excessive amount of LiXO₂ remains as residue after dispersion, which is not favorable to cost efficiency.

In addition, there is no particular limitation in amount of Li₂MnO₃ introduced to the solution containing LiXO₂ dispersed therein, as long as LiXO₂ is coated sufficiently with Li₂MnO₃. However, Li₂MnO₃ may be introduced to LiXO₂ at a molar ratio of 1-9:1-9 (LiXO₂:Li₂MnO₃). When Li₂MnO₃ is introduced in a molar ratio less than 9:1, it is not possible to obtain a sufficient coating effect and sufficient modification of LiXO₂. On the other hand, when Li₂MnO₃ is introduced in a molar ratio larger than 1:9, an excessively large amount of Li₂MnO₃ is introduced in view of a sufficient coating effect.

There is no particular limitation in the method for mixing the solution containing LiXO₂ dispersed therein with Li₂MnO₃ as long as they are mixed adequately with each other. Particularly, any known apparatus for agitation and stirring may be used.

After mixing, the resultant mixture may be dried to obtain the cathode active material for a lithium secondary battery disclosed herein.

There is no particular limitation in the drying method as long as the method provides the cathode active material for a lithium secondary battery disclosed herein. In addition, there is no particular limitation in the drying temperature, as long as the cathode active material for a lithium secondary battery disclosed herein is provided and is not damaged.

After drying the mixture, the method may further include heat treating the mixture. Such heat treatment allows the cathode active material for a lithium secondary battery including LiXO₂ coated with Li₂MnO₃ to undergo oxidation more sufficiently and to have a denser structure.

The temperature of the heat treatment carried out after the drying is not particularly limited, as long as the heat treatment allows sufficient oxidation and densification of the structure. Particularly, the heat treatment may be carried out at a temperature of 400-1,100° C. When the temperature is lower than 400° C., it is not possible to obtain a sufficient effect of heat treatment. On the other hand, when the temperature is higher than 1,100, the Li₂MnO₃ coating may be damaged and the cathode active material for a lithium secondary battery may undergo degradation of its functions.

The heat treatment may be carried out by introducing air or oxygen. Such heat treatment carried out by introducing air or oxygen provides higher effect of oxidation.

After carrying out the method, it is possible to obtain the cathode active material for a lithium secondary battery including LiXO₂ coated with Li₂MnO₃ disclosed herein.

In the case of a cathode active material for a lithium secondary battery based on LiXO₂ alone, a cathode is degraded during the repeated charge/discharge cycles of a lithium secondary battery and thus the lithium secondary battery causes degradation of lifespan. However, the cathode active material for a lithium secondary battery including LiXO₂ coated with Li₂MnO₃ disclosed herein allows a lithium secondary battery to maintain its capacity even after repeated charge/discharge cycles, and thus improves the lifespan of a lithium secondary battery.

In still another aspect, the lithium secondary battery disclosed herein includes the cathode active material disclosed herein.

The lithium secondary may include any types of lithium secondary batteries known to those skilled in the art.

### EXAMPLES

The examples and experiments will now be described. The following examples and experiments are for illustrative purposes only and not intended to limit the scope of this disclosure.

### Example 1

First, Mn₂O₃ and Li₂CO₃ are pulverized and mixed homogeneously with each other through a mechanochemical process in such a manner that the molar ratio of manganese:lithium is 1:2, and then subjected to heat treatment under air at 500° C. for 12 hours to form uniform Li₂MnO₃ having a size of about 50 nm.

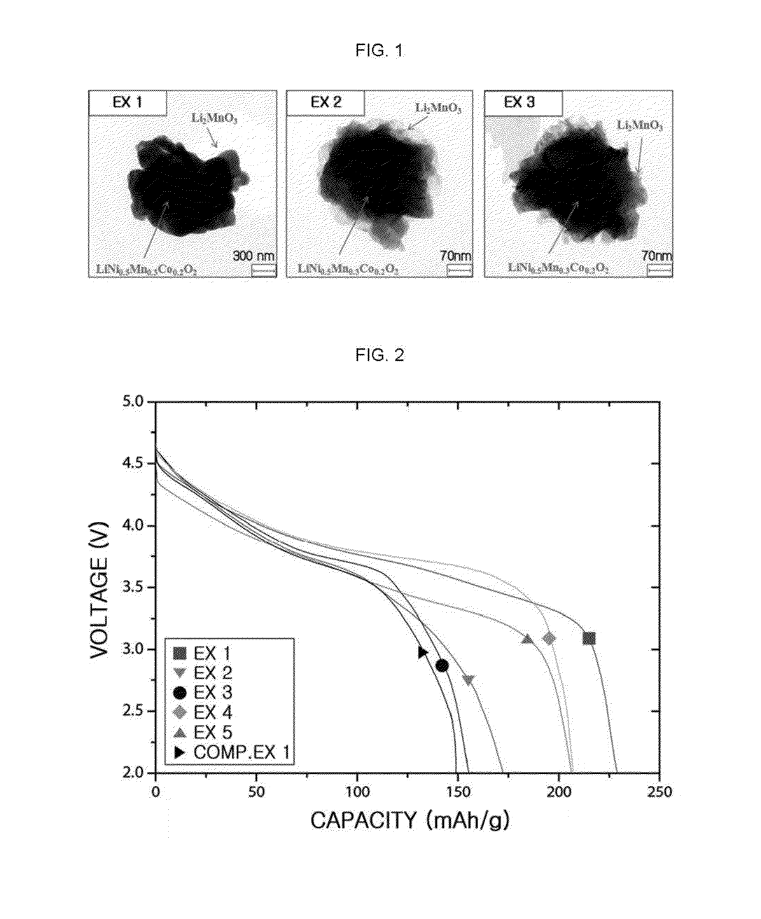

Then, 10 g of LiNi_{0.5}Mn_{0.3}Co_{0.2}O₂ as a cathode active material and 0.1 g of Triton-X are introduced to 50 mL of distilled water, and dispersed by using ultrasonic waves for 5-10 minutes. Next, uniform Li₂MnO₃ having a size of about 50 nm in solution is introduced thereto in such a manner that the molar ratio of Li₂MnO₃:LiNi_{0.5}Mn_{0.3}Co_{0.2}O₂ as a cathode active material is 1:1. After the completion of introduction, the materials are mixed homogeneously for 30 minutes and water is dried sufficiently, followed by pulverization. Then, heat treatment is carried out under air at 1,000° C. for 10 hours to obtain a cathode active material including LiNi_{0.5}Mn_{0.3}Co_{0.2}O₂ coated with Li₂MnO₃. The cathode active material including LiNi_{0.5}Mn_{0.3}Co_{0.2}O₂ coated with Li₂MnO₃ is shown in FIG. 1 in the form a TEM image.

Then, 0.5 g of the cathode active material including LiNi_{0.5}Mn_{0.3}Co_{0.2}O₂ coated with Li₂MnO₃, 0.03 g of Denka black and 0.04 g of PVDF are mixed and NMP is added thereto to reach an adequate level of viscosity. The resultant material is cast onto an aluminum foil, followed by drying and rolling, to provide an electrode of LiNi_{0.5}Mn_{0.3}Co_{0.2}O₂ coated with Li₂MnO₃.

The electrode of LiNi_{0.5}Mn_{0.3}Co_{0.2}O₂ coated with Li₂MnO₃, a separator made of polypropylene (PP) and lithium metal as a counter electrode are used to provide a half cell of a lithium secondary battery, thereby providing a finished lithium secondary battery.

### Example 2

Example 1 is repeated to provide a cathode active material for a lithium secondary battery including LiNi_{0.5}Mn_{0.3}Co_{0.2}O₂ coated with Li₂MnO₃ and a lithium secondary battery including the same, except that the temperature of the heat treatment carried out after mixing Li₂MnO₃ with LiNi_{0.5}Mn_{0.3}Co_{0.2}O₂ is changed from 1000° C. to 700° C.

### Example 3

Example 1 is repeated to provide a cathode active material for a lithium secondary battery including LiNi_{0.5}Mn_{0.3}Co_{0.2}O₂ coated with Li₂MnO₃ and a lithium secondary battery including the same, except that the temperature of the heat treatment carried out after mixing Li₂MnO₃ with LiNi_{0.5}Mn_{0.3}Co_{0.2}O₂ is changed from 1000° C. to 400° C.

### Example 4

Example 1 is repeated to provide a lithium secondary battery, except that Li₂MnO₃ is mixed with LiNi_{0.5}Mn_{0.3}Co_{0.2}O₂ in a molar ratio of 3:7 to obtain a cathode active material including LiNi_{0.5}Mn_{0.3}Co_{0.2}O₂ coated with Li₂MnO₃.

### Example 5

Example 1 is repeated to provide a lithium secondary battery, except that Li₂MnO₃ is mixed with LiNi_{0.5}Mn_{0.3}Co_{0.2}O₂ in a molar ratio of 7:3 to obtain a cathode active material including LiNi_{0.5}Mn_{0.3}Co_{0.2}O₂ coated with Li₂MnO₃.

### Comparative Example 1

Example 1 is repeated to provide a lithium secondary battery, except that a cathode active material merely including LiNi_{0.5}Mn_{0.3}Co_{0.2}O₂ not coated with Li₂MnO₃ is used.

### Test Examples

### Test Example 1

### Determination of Optimum Heat Treatment Temperature

Example 1, Example 2 and Example 3, in which different heat temperatures are used, are investigated to determine the temperature capable of realizing an optimized coating state. The results are shown in FIG. 1.

FIG. 1 is a scanning electron microscopy (SEM) image of the cathode active materials for a lithium secondary battery including LiNi_{0.5}Mn_{0.3}Co_{0.2}O₂ coated with Li₂MnO₃ according to Examples 1-3.

In the case of Example 1, a dark color is maintained even at the outer layer. However, it can be seen from Examples 2 and 3 that the color of the outer layer becomes blurred and cloudy as compared to Example 1.

This demonstrates that when the heat treatment is carried out at 1,000° C., Li₂MnO₃ is not significantly scattered and a darker color is maintained, indicating that the coating is denser and has higher quality.

### Test Example 2

### Determination of Efficiency Depending on Variation in Voltage

Examples 1-5 and Comparative Example 1 are subjected to a test for determining capacity in a constant-current charge/discharge mode at a current density of 0.05 C in a range of potential of 2.0-4.8V, after a solution of EC:DMC:EMC (1:1:1) in which 1M LiPF₆ is dissolved is introduced thereto. In this manner, the capacity efficiency of each lithium secondary battery at high voltage is determined. The results are shown in FIG. 2.

As can be seen from FIG. 2, all of the above Examples cause no rapid decrease in capacity and show no increase in capacity drop despite an increase of voltage up to a high voltage of 3.0-3.5V. However, unlike Examples, Comparative Example 1 shows the highest capacity and maintains capacity at a high voltage of about 3.5V merely within a range of 100-150 mAh/g.

On the contrary, Example 1 maintains its maximum capacity at a high voltage of 3.0-3.5V, and maintains a capacity of about 200-235 mAh/g. In brief, as compared to Comparative Example 1, Example 1 maintains higher capacity even at high voltage. This demonstrates that Example 1 using the cathode active material disclosed herein provides a lithium secondary battery with higher quality as compared to Comparative Example 1.

In addition, Examples 4 and 5 in which different amounts of Li₂MnO₃ are used show a slightly lower maximum capacity as compared to Example 1. However, as compared to Comparative Example 1, Examples 4 and 5 have a higher maximum capacity of 200 mAh/g or more and maintain the maximum capacity without any significant capacity drop even at high voltage. Thus, Examples 4 and 5 provide high-quality lithium secondary batteries.

As determined from Test Example 1, the surface coating states in Examples 2 and 3 are degraded as compared to Example 1. Thus, the maximum capacity and the highest capacity maintained at high voltage are lower than those of Example 1 but higher than those of Comparative Example 1. This demonstrates that the cathode active material having Li₂MnO₃ coating provides a lithium secondary battery with higher quality as compared to the same material having no coating.

### Test Example 3

### Determination of Variation in Capacity Depending on Number of Charge/Discharge Cycles

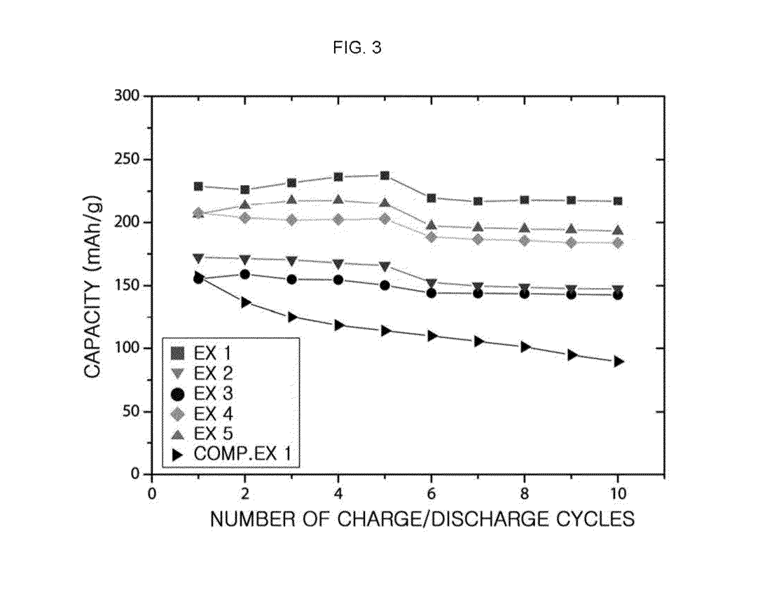

Examples 1-5 and Comparative Example 1 are subjected to a test to determine whether or not each battery maintains capacity with no capacity drop during repeated charge/discharge cycles. The test condition is the same as Test Example 2. The results are shown in FIG. 3.

As can be seen from FIG. 3, all of the above Examples have significantly higher capacity as compared to Comparative Example 1, and Example 1 particularly has the highest capacity.

While Comparative Example 1 undergoes a rapid drop in capacity as the number of repetition of charge/discharge cycles increases, Examples 1-5 maintains capacity despite repetition of charge/discharge cycles.

More particularly, each of Examples 1-5 maintains its capacity with no exception to such a degree that the capacity after repeating charge/discharge cycles six times or more is substantially the same as the capacity of the 6^{th} cycle.

In other words, it can be seen that each Example maintains its capacity to such a degree that the capacity after repeating charge/discharge cycles six times or more is within ±5 mAh/g as compared to the capacity of the 6^{th} cycle. The graph showing the capacity of each of Examples 1-5 shows no variation in gradient even after the 6^{th} charge/discharge cycle and maintains a horizontal gradient. This supports the test results.

Further, the test results demonstrating that the capacity is maintained at the substantially same level despite repetition of charge/discharge cycles also support that the lithium secondary battery maintains a predetermined capacity continuously. This also means that the lithium secondary battery disclosed herein has significantly improved lifespan as compared to Comparative Example 1.

As can be seen from the foregoing, the cathode active material for a lithium secondary battery including LiXO₂ coated with Li₂MnO₃ allows a lithium secondary battery to provide high capacity and high efficiency, and to have significantly improved lifespan.

While the present disclosure has been described with respect to the specific embodiments, it will be apparent to those skilled in the art that various changes and modifications may be made without departing from the spirit and scope of the disclosure as defined in the following claims.

1. A cathode active material for a lithium secondary battery, comprising LiXO₂ coated with Li₂MnO₃, wherein X is at least one metal selected from the group consisting of nickel (Ni), cobalt (Co), manganese (Mn), aluminum (Al), copper (Cu), iron (Fe), magnesium (Mg), bismuth (Bi) and gallium (Ga).

2. The cathode active material for a lithium secondary battery according to claim 1, wherein LiXO₂ is at least one selected from the group consisting of LiCoO₂, LiNiO₂, LiNixCo₁₋ₓO₂ (wherein 0<x<1) and LiNi_{1-x-y}CoₓX′_{y}O₂ (wherein 0<x<1, 0<y<1 and 0<x+y<1, and X′ is at least one selected from the group consisting of aluminum (Al), strontium (Sr), magnesium (Mg), iron (Fe) and manganese (Mn)).

3. The cathode active material for a lithium secondary battery according to claim 1, wherein the Li₂MnO₃ coating has a thickness of 10 nm-500 nm.

4. The cathode active material for a lithium secondary battery according to claim 1, wherein a lithium secondary battery including the cathode active material maintains its capacity to such a degree that the capacity after repeating charge/discharge cycles six times or more is within ±5 mAh/g as compared to the capacity of the 6^{th} cycle.

5. A method for preparing a cathode active material for a lithium secondary battery, comprising:
mixing a lithium compound with a manganese compound to obtain Li₂MnO₃;
introducing Li₂MnO₃ to a solution in which LiXO₂ is dispersed and mixing them so that LiXO₂ is coated with Li₂MnO₃; and
drying the resultant mixed solution,
wherein X is at least one metal selected from the group consisting of nickel (Ni), cobalt (Co), manganese (Mn), aluminum (Al), copper (Cu), iron (Fe), magnesium (Mg), bismuth (Bi) and gallium (Ga).

6. The method for preparing a cathode active material for a lithium secondary battery according to claim 5, wherein the Li₂MnO₃ coating has a thickness of 10 nm-500 nm.

7. The method for preparing a cathode active material for a lithium secondary battery according to claim 5, wherein the lithium compound is LiCO₃ or LiOH, and the manganese compound is at least one selected from the group consisting of Mn₂O₃, MnO₂, MnO, Mn₃O₄ and Mn(OH)₂.

8. The method for preparing a cathode active material for a lithium secondary battery according to claim 5, which further comprises, after mixing a lithium compound with a manganese compound, heat treating the resultant mixture to obtain Li₂MnO₃.

9. The method for preparing a cathode active material for a lithium secondary battery according to claim 5, which further comprises carrying out heating treatment, after drying the mixed solution.

10. The method for preparing a cathode active material for a lithium secondary battery according to claim 9, wherein the heat treatment is carried out by introducing air or oxygen.

11. The method for preparing a cathode active material for a lithium secondary battery according to claim 8, wherein the heat treatment is carried out at a temperature of 400-1,100° C.

12. The method for preparing a cathode active material for a lithium secondary battery according to claim 5, wherein said mixing the lithium compound with the manganese compound is carried out by adding thereto at least one element selected from the group consisting of magnesium (Mg), aluminum (Al), calcium (Ca), titanium (Ti), vanadium (V), chrome (Cr), iron (Fe), copper (Cu), zinc (Zn), gallium (Ga), zirconium (Zr), molybdenum (Mo), tin (Sn), antimony (Sb), tungsten (W) and bismuth (Bi).

13. The method for preparing a cathode active material for a lithium secondary battery according to claim 5, wherein LiXO₂ is at least one selected from the group consisting of LiCoO₂, LiNiO₂, LiNixCo₁₋ₓO₂ (wherein 0<x<1) and LiNi_{1-x-y}CoₓX′_{y}O₂ (wherein 0<x<1, 0<y<1 and 0<x+y<1, and X′ is at least one selected from the group consisting of aluminum (Al), strontium (Sr), magnesium (Mg), iron (Fe) and manganese (Mn)).

14. The method for preparing a cathode active material for a lithium secondary battery according to claim 5, wherein the lithium compound and the manganese compound are mixed with each other at a molar ratio of 1-3:0.5-1.5.

15. The method for preparing a cathode active material for a lithium secondary battery according to claim 5, wherein the solution in which LiXO₂ is dispersed comprises LiXO₂ in an amount of 5-40 wt % based on the weight of the solvent.

16. The method for preparing a cathode active material for a lithium secondary battery according to claim 5, wherein Li₂MnO₃ is introduced to LiXO₂ at a molar ratio of 1-9:1-9 (LiXO₂:Li₂MnO₃).

17. A lithium secondary battery comprising the cathode active material for a lithium secondary battery as defined in claim 1.
